(19) United States
(12) Patent Application Publication
(10) Pub. No.: US 2011/0029510 A1
(43) Pub. Date: Feb. 3, 2011

(54) METHOD AND APPARATUS FOR SEARCHING A PLURALITY OF STORED DIGITAL IMAGES

(75) Inventors: Bart Kroon, Rotterdam (NL); Sabri Boughorbel, Eindhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/936,533

(22) PCT Filed: Apr. 14, 2009
(86) PCT No.: PCT/IB2009/051545

§ 371 Date: Oct. 6, 2010

(30) Foreign Application Priority Data
Apr. 14, 2008 (EP) 08154466.0

(51) Int. Cl. G06F 17/30

(52) U.S. Cl. 707/723; 707/E17.084

(57) ABSTRACT

A plurality of stored digital images are searched. Images are retrieved in accordance with a search query (step 204). The retrieved images are clustered according to a predetermined characteristic of the content of the image (step208). The clusters are ranked on the basis of a predetermined criterion (step 210). Search results are returned according to the ranked clusters (step 212).

### FIELD OF THE INVENTION

The present invention relates to a method and apparatus for searching a plurality of stored digital images.

### BACKGROUND TO THE INVENTION

The retrieval of multimedia content such as images and video is of global interest. Due to the vast amount of available multimedia content, efficient retrieval methods are necessary for both consumer and business markets. The use of image search engines has become a popular method for finding and retrieving images. In general, such systems rely on tagging images by text. The text mainly consists of a file name or text extracted from the document containing the images.

Since image retrieval relies almost only on the text features that accompany the images, the image retrieval process can be problematic. For example, such text information is not always reliable and in many cases the information is “noisy” information. For instance, in web sites, the file names of the images are chosen arbitrarily depending on the order in which the images were added to the system. Furthermore, it is difficult to extract relevant text information from pages in which the text mentions many different objects not necessarily related to the objects shown in the accompanying images. For example, the text may mention many different people that are not shown in the accompanying images.

Additionally, some names are very common and it is therefore difficult for users to find images of a person that they have in mind. For example, on the Internet, people who appear on many web pages outrank people of the same name who appear on very few web pages. This makes it impossible to find images of people who have common names or whose names also belong to celebrities.

The existing image retrieval methods therefore frequently return inaccurate search results. Also, large numbers of results are returned making it difficult for the user to refine and obtain usable results. It would therefore be desirable to have a search engine, which generates accurate and consistent results, and which provides refined search results.

### SUMMARY OF INVENTION

The present invention seeks to provide a system, which generates accurate and consistent search results and which enables these results to be further refined.

This is achieved, according to an aspect of the invention, by a method for searching a plurality of stored digital images, the method comprising the steps of: retrieving images in accordance with a search query; clustering said retrieved images according to a predetermined characteristic of the content of the image; ranking clusters on the basis of a predetermined criterion; and returning search results according to the ranked clusters. The search query may comprise the name of a person, for example, or another text.

This is also achieved, according to another aspect of the invention, by an apparatus for searching a plurality of stored digital images, the apparatus comprising: retrieving means for retrieving images in accordance with a search query; clustering means for clustering said retrieved images according to a predetermined characteristic of the content of the image; ranking means for ranking clusters on the basis of a predetermined criterion; and output means for returning search results according to the ranked clusters. The search query may comprise the name of a person, for example, or another text.

In this way, accurate search results are returned because the images are clustered according to their content. Also, the search results are refined since they are ranked according to a predetermined criterion. As a result, the returned results are more specific to the search query and are easier to interpret.

A digital image may be a video data stream, a still digital image such as a photograph, a website, or an image with metadata etc.

The predetermined characteristic may be a predetermined feature of an object, such as a predetermined facial feature of a person. The retrieved images may be clustered by using results of face detection and clustering retrieved images that include faces that have the same/similar facial features. In this way, images of a specific person can be found. Alternatively, the retrieved images may be clustered according to their scenery content, for example, by clustering images of woodland scenes and clustering images of urban scenes. Alternatively, the retrieved images may be clustered according to objects or the types of animals included in the images or any other predetermined characteristics of the content.

The predetermined criterion may be the size of a cluster and the step of ranking may comprise ranking clusters in order of the size of the clusters, for example, largest first or they may be ranked according to the user preference or according to an access history such that the most popular or most recent are displayed first. In this way, the most relevant clusters are given more weight by ranking them higher than less relevant clusters. This provides a more refined search.

The search results may be returned by displaying representative images of at least one of the clusters. The displayed representative images may be accompanied by text or audio data related to the displayed image. Upon selection of the displayed representative image, all images in the cluster associated with the selected representative image may be displayed. In this way, the user is presented with a condensed menu in the form of representative images. The user need only navigate through a small number of displayed representative images to find images relating to their search query. This achieves a further refinement in providing a simple and efficient method for viewing and interpreting the results.

The ranking of the clusters may be adjusted on the basis of the selected displayed representative image. In this way, the results are further refined to provide the user with images that are ranked in accordance with the user's interest.

### BRIEF DESCRIPTION OF DRAWINGS

For a more complete understanding of the present invention, reference is now made to the following description taken in conjunction with the accompanying drawings in which:

FIG. 1 is a simplified schematic of apparatus for searching a plurality of stored digital images according to an embodiment of the invention; and

FIG. 2 is a flowchart of a method for searching a plurality of stored digital images according to an embodiment of the present invention.

### DETAILED DESCRIPTION OF EMBODIMENTS OF THE INVENTION

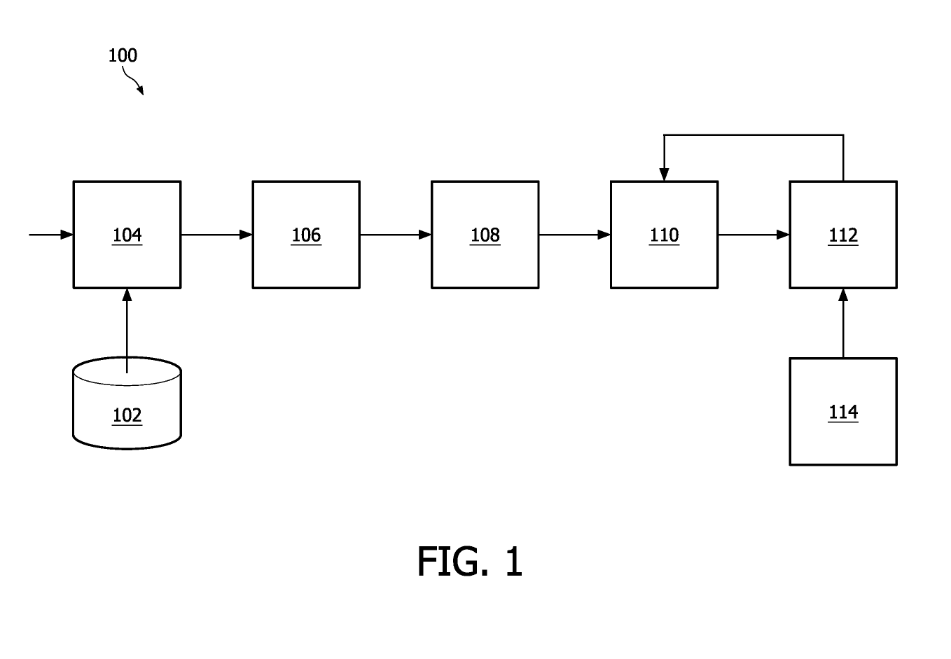

With reference to FIG. 1, the apparatus 100 comprises a database 102, the output of which is connected to the input of a retrieving means 104. The retrieving means 104 may, for example, be a search engine such as a web or desktop search engine. The output of the retrieving means 104 is connected to the input of a detection means 106. The output of the detection means 106 is connected to the input of a clustering means 108. The output of the clustering means 108 is connected to the input of a ranking means 110. The output of the ranking means 110 is connected to the input of an output means 112 and the output of the output means 114 is in turn connected to the input of the ranking means 110. A user input can be provided to the output means 112 via a selecting means 114.

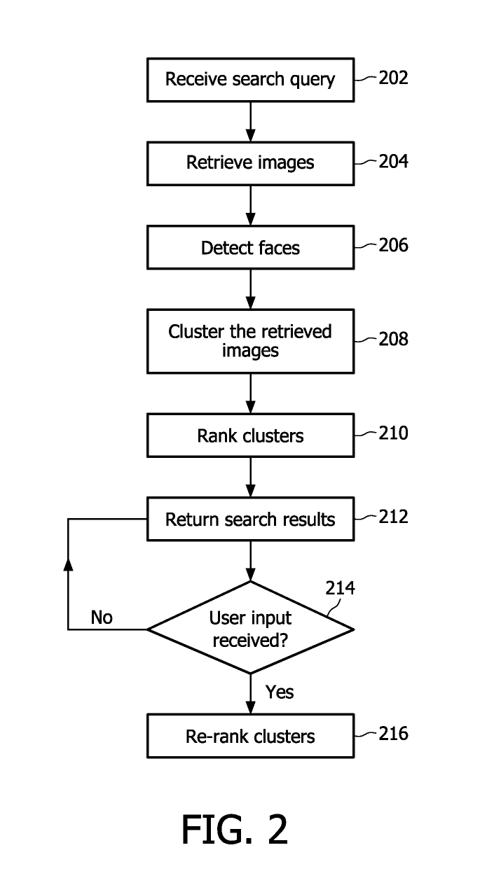

With reference to FIGS. 1 and 2, in operation, a search query is input into the retrieving means 104 (step 202). The retrieving means 104 has access to the database 102. The database 102 is an index, which is a list of references to original data (e.g. website urls) and descriptive information (e.g. metadata). The original data may include, for example, digital images such as a video data stream, or still digital images (e.g. photographs). The retrieving means 104 may constantly search, for example, the web for new digital images. The retrieving means 104 constantly indexes the new digital images and adds the new indexed digital images to the database 102 with related descriptive information. Upon input of a search query, the retrieving means 104 performs a search on the text in the database 102 and retrieves images in accordance with the search query (step 204).

The retrieved images are input into the detection means 106. The detection means 106 may be, for example, a face detector. Alternatively, the detection means 106 may be a scenery content detector or a detector that detects an object shape or types of animals etc. In the case of a face detector, the detection means 106 detects faces within the retrieved images (step 206). This may be achieved by detecting, in the retrieved images, the areas that contain faces and finding the position and size of all the faces in the retrieved images. The method of detecting faces in images is known as face detection. An example of a face detection method is disclosed, for example, in “Rapid object detection using a boosted cascade of simple features”, P. Viola, and M. Jones, IEEE Computer Society Conference on Computer Vision and Pattern Recognition, 2001. The identity of a person may be determined based on the appearance of the face of the person in an image. This method of identifying a person is known as face recognition. An example of a face recognition method is disclosed, for example, in “Comparison of Face Matching Techniques under Pose Variation”, B. Kroon, S. Boughorbel, and A. Hanjalic, ACM Conference on Image and Video Retrieval, 2007.

The detection means 106 outputs the retrieved images and the detected faces to the clustering means 108.

Alternatively, the detection means 106 may perform detection in advance for each digital image that the retrieval means 104 indexes. In this way, the retrieval means 104 continually searches the web for new digital images, indexing any new digital images that are found and the detection means 106 performs detection on each of the indexed digital images. The database 102 would then contain references to the digital images and the facial features of all the detected faces for each digital image, which could be retrieved by the retrieval means 104 upon input of a search query and input into the clustering means 108. This enables the system to perform quickly and efficiently since detection does not need to be performed every time a search query is input.

The clustering means 108 clusters the retrieved images according to a predetermined characteristic of the content of the image (step 208). The predetermined characteristic may be, for example, a predetermined feature of an object such as a predetermined facial feature of a person. The clustering means 108 may use multiple facial features to cluster the retrieved images. Alternatively, the predetermined characteristic may be an image characteristic such as texture. In the case of facial features, the clustering means 108 clusters retrieved images that include faces that have the same or similar features. Features that are the same or similar are likely to belong to the same person. Alternatively, the clustering means 108 may cluster retrieved images that include related scenery content. For example, the clustering means 108 may cluster all images that relate to a woodland scene and all images that relate to an urban scene. Alternatively, the clustering means 108 may cluster images that include a certain object or type of animal etc. Examples of clustering techniques are disclosed in WO2006/095292, US2007/0296863, WO2007/036843 and

US2003/0210808.

The clusters are output from the clustering means 108 into the ranking means 110. The ranking means 110 ranks clusters on the basis of a predetermined criterion (step 210). The predetermined criterion may be, for example, the size of a cluster. The ranking means 110 ranks the clusters in order of the size of the clusters, for example, with the largest cluster first. The size of a cluster indicates how often an object (e.g. a person) occurs in the retrieved images. The bigger the cluster, the more likely the cluster is to feature the queried person. Smaller clusters may feature persons that have some semantic relation to the target. For example, in a query about the Italian politician Prodi or Berlusconi, bigger clusters may represent Prodi or Berlusconi, whereas smaller clusters may feature other politicians or different persons with the same name. Alternatively, the ranking means 110 may rank clusters according to the user preference or according to an access history such that the most popular or most recent are displayed first. In this way, the most popular or most recent clusters (i.e. the most relevant clusters) are given more weight by ranking them higher than less relevant clusters.

The ranked clusters are output from the ranking means 110 and are input into the output means 112. The output means 112 returns search results according to the ranked clusters (step 212). The output means 112 may, for example, be a display. The output device 112 may return search results by displaying representative images of at least one of the clusters. The displayed representative images may be accompanied by text and/or audio data related to the displayed images.

A user can select a displayed representative image via the selecting means 114 (step 214). Upon selection of a displayed representative image, the output means 112 displays all images in the cluster associated with the selected representative image. The output means 112 uses a hierarchical representation of the search results.

The output means 112 may use a relevance feedback option when returning search results. The output means 112 outputs the selected representative images to the ranking means 110. The ranking means 110 then adjusts the ranking of the clusters by giving more weight to the clusters corresponding to the selected representative images (step 216). In other words, when a user selects a representative image, the cluster corresponding to the selected representative image is moved up in the ranked clusters such that it appears first, for example. In this way, the clusters that are of more interest to the user are displayed first making it easier for the user to refine and obtain usable results. The ranking means 110 outputs the re-ranked clusters to the output means 112 for display.

Although embodiment of the present invention have been illustrated in the accompanying drawings and described in the foregoing description, it will be understood that the invention is not limited to the embodiments disclosed but capable of numerous modifications without departing from the scope of the invention as set out in the following claims. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for searching a plurality of stored digital images, the method comprising the steps of:
retrieving images in accordance with a search query;
clustering said retrieved images according to a predetermined characteristic of the content of the image;
ranking clusters on the basis of a predetermined criterion; and
returning search results according to the ranked clusters.

2. A method according to claim 1, wherein the predetermined characteristic is a predetermined feature of an object.

3. A method according to claim 2, wherein the predetermined characteristic of an object is a predetermined facial feature of a person.

4. A method according to claim 3, wherein the step of clustering retrieved images comprises:
using results of face detection; and
clustering retrieved images that include faces that have the same/similar facial features.

5. A method according to claim 1, wherein the predetermined criterion is the size of a cluster and wherein the step of ranking comprises ranking clusters in order of the size of the clusters.

6. A method according to claim 1, wherein the step of returning search results comprises displaying representative images of at least one of the clusters.

7. A method according to claim 6 wherein the step of returning search results further comprises the steps of:
selecting one of said displayed representative images; and
displaying all images in the cluster associated with said selected representative image.

8. A method according to claim 6, wherein the step of returning search results further comprises providing text or audio data related to the displayed image.

9. A method according to claim 7 further comprising the step of adjusting the ranking of the clusters on the basis of the selected displayed representative image.

10. A computer program product comprising a plurality of program code portions for carrying out the method according to claim 1.

11. Apparatus for searching a plurality of stored digital images, the apparatus comprising:
retrieving means for retrieving images in accordance with a search query;
clustering means for clustering said retrieved images according to a predetermined characteristic of the content of the image;
ranking means for ranking clusters on the basis of a predetermined criterion; and
output means for returning search results according to the ranked clusters.

12. Apparatus according to claim 11 further comprising:
detection means for detecting faces within the retrieved images; and wherein the clustering means is operable to cluster retrieved images that include faces that have the same/similar facial features.

13. Apparatus according to claim 11, wherein the output means includes a display for displaying representative images of at least one of the clusters and wherein the apparatus further comprises selection means for selecting the representative images.
